(19) United States
(12) Patent Application Publication
(10) Pub. No.: US 2008/0202558 A1
(43) Pub. Date: Aug. 28, 2008

(54) METHOD FOR OPERATING A CONTINUOUS-FLOW DISHWASHING MACHINE

(76) Inventor: Bruno Gaus, Offenburg (DE)

Correspondence Address: Muncy, Geissler, Olds & Lowe, PLLC, P.O. BOX 1364, FAIRFAX, VA, 22038-1364, US

(21) Appl. No.: 12/036,155

(22) Filed: Feb. 22, 2008

Related U.S. Application Data
(60) Provisional application No. 60/907,326, filed on Mar. 28, 2007.

(30) Foreign Application Priority Data
Feb. 22, 2007 (DE) DE10 2007009252.2

(51) Int. Cl. A47L 15/42; A47L 15/46; A47L 15/00; B08B 3/04

(52) U.S. Cl. 134/18; 134/61; 134/57 D

(57) ABSTRACT

A continuous-flow dishwashing machine and a method for operating the dishwasher is provided. The continuous-flow dishwashing machine is used for cleaning items to be cleaned and has a feed device for transportation of the items to be cleaned in the feed direction through successive treatment zones in the continuous-flow dishwashing machine. This optionally contains an initial cleaning zone, at least one cleaning zone, at least one rinsing zone and, optionally, a drying zone. Means are provided in the at least one rinsing zone in order to supply dishwashing liquid for the at least one rinsing zone to at least one cleaning zone and/or to the initial cleaning zone, as required by a machine controller and governed by a controller, with the decision on the zone to which the dishwashing liquid for the at least one rinsing zone is passed depending inter alia on level states in the at least one cleaning zone and the at least one rinsing zone.

This nonprovisional application claims priority to German Patent Application No. 10 2007 009 252.2, which was filed in Germany on Feb. 22, 2007, and to U.S. Provisional Application No. 60/907,326, which was filed on Mar. 28, 2007, and which are both herein incorporated by reference.

### BACKGROUND OF THE INVENTION

1. Field of the Invention

The invention relates to a method for water-saving operation of cleaning machines, in particular of continuous-flow dishwashing machines cleaning items to be cleaned.

2. Description of the Background Art

Automatic cleaning machines, in particular continuous flow dishwashing machines which are used in particular for the cleaning of plates, dishes and trays that need to be cleaned having been used for communal purposes, are generally known. While dishwashing apparatuses for the domestic field in general carry out a program procedure with the successive cleaning steps with the plates, dishes and the flatware to be cleaned being arranged in fixed positions, the treatment zones in continuous-flow dishwashing machines are arranged successively, and the items to be cleaned, or the item to be cleaned, are/is transported through the successive treatment zones by means of suitably designed feed means.

Conventional continuous-flow dishwashing machines generally have four different treatment zones, that is to say an initial cleaning zone, at least one cleaning zone, a rinsing zone and a drying zone. Slightly adhering dirt is removed from the item to be cleaned in the initial cleaning zone. For this purpose, dishwashing liquid is sucked up by a pump from the reservoir tank associated with this treatment zone, and is sprayed over the items to be cleaned through suitably designed nozzles. The dishwashing liquid then flows back again to the reservoir tank where it is sucked up once again by the pump. The reservoir tank is normally covered by a filter in order to keep relatively large dirt particles away from the dishwashing liquid.

Dirt particles which are still adhering to the items to be cleaned are removed from them in the at least one cleaning zone, which follows the initial cleaning zone, by means of a normally alkaline dishwashing liquid. For this purpose, the dishwashing liquid is sucked up by a further pump from the reservoir tank associated with this treatment zone, and is sprayed over the items to be cleaned by means of nozzles. The dishwashing liquid then flows back again to the reservoir tank, where it is sucked up once again by the pump. The reservoir tank is normally covered by a filter, in order to keep relatively large dirt particles out of the dishwashing liquid.

In the rinsing zone, which follows the at least one cleaning zone, the alkaline dishwashing liquid which has wetted the surface of the items to be cleaned is rinsed away, together with any food residues which may still remain there, from the surface of the item to be cleaned by means of hot fresh water, to which a rinsing agent is generally added. In certain embodiments of the rinsing zone, the fresh water is once again passed to a reservoir tank, which is associated with this treatment zone, following this treatment step, is sucked up by a pump and is distributed over the items to be cleaned by means of nozzles before the actual fresh-water rinsing process. The dishwashing liquid then flows back again into the reservoir tank where it is once again sucked up by the pump.

Air is blown into the circuit over the items to be cleaned by means of a fan in the drying zone. This results in the dishwashing liquid that remains on the items that have been cleaned being removed partially by blowing them off and partially by vaporization from the items that have been cleaned.

The fresh water supplied in the rinsing zone normally flows in the opposite direction to the transport direction of the feed means via a cascade to the reservoir tank of the respectively preceding treatment zone. The dishwashing liquid in the initial cleaning zone normally flows directly via an overflow into the waste water. This water supply process results in permanent regeneration of the dishwashing liquid in the individual treatment zones without any additional fresh water being required. In this case, all of the fresh water that is supplied in the rinsing zone can be passed over the cascade, or only a part of its volume. The remaining part bypasses the cleaning zone by means of a so-called bypass line, and is supplied directly to the initial cleaning zone or to the waste water.

A continuous-flow dishwashing machine in which some of the dishwashing liquid is supplied from the rinsing zone by means of a bypass line to the initial cleaning zone is disclosed in DE 44 28 738 A1. A pump sucks up dishwashing liquid from the dishwashing liquid reservoir tank associated with the rinsing zone and sprays it by means of nozzles over the items to be cleaned. A bypass, which starts at the supply line to the spray nozzles, passes dishwashing liquid via a valve into the reservoir tank for the initial cleaning zone. The volume which is passed via the bypass line is predetermined by a valve with a fixed-setting flow opening or, for example, with a restrictor aperture.

This method has the disadvantage that a solution such as this is sensitive to the nozzles or the valve in the bypass line becoming blocked. If the spray nozzles in the rinsing zone become blocked, the pressure in the supply line to the nozzles increases, thus also increasing the pressure in the bypass line. The pressure increase results in an additional increase in the volume which is passed via the bypass line. At the same time, the volume which is passed via the cascades decreases. This can even lead to a lack of water in the dishwashing liquid reservoir tank which must be compensated for by replenishment with fresh water, thus in turn leading to considerably more consumption of water and to considerably more consumption of energy, since the fresh water that is supplied must be heated to at least 60° C.

If the valve or restrictor aperture become blocked, the amount of water passed via the bypass line is partially reduced, or is entirely blocked, depending on the degree of blockage. This results in all of the fresh water carried in the rinsing zone being supplied via the cascades to the cleaning zone. Although this increases the amount of water replaced in this zone thus resulting in less dirt being contained in the dishwashing liquid in this zone, the concentration of the cleaner added in this zone decreases, however, at the same time. This must be compensated for by adding cleaner, thus once again resulting in costs and environmental contamination.

U.S. Pat. No. 4,561,904 discloses a machine in which all of the fresh water that is supplied to the rinsing zone flows via cascades to the first treatment zone, where it leaves the dishwashing machine via an overflow. EP 0 838 190 D1 discloses a solution in which some of the dishwashing liquid for the rinsing zone is supplied via a nozzle to the dishwashing liquid reservoir tank for the cleaning zone. A pump sucks dishwashing liquid up from the dishwashing liquid reservoir tank associated with the rinsing zone and sprays it by means of nozzles over the items to be cleaned. A bypass which starts at the supply line to the spray nozzles dissipates dishwashing liquid via a valve into the reservoir tank for the initial cleaning zone. The volume which is passed via the bypass line can be set or controlled by means of a valve. If the nozzle which sprays the dishwashing liquid from the rinsing zone into the cleaning zone becomes blocked, the volume which is passed via this path is decreased entirely or partially. This reduces the amount of regeneration water which is supplied to the cleaner tank, and this in turn leads to an increase in the amount of dirt in the dishwashing liquid in the cleaner tank, and to a decrease in the cleaning performance in the corresponding zone. This is undesirable.

The solutions mentioned above all have the disadvantage that either the dishwashing liquid that is supplied to the cleaner zone or the initial cleaning zone from the dishwashing liquid reservoir tank for the rinsing zone is constant, and that any dishwashing liquid loss that may occur in the cleaning zone cannot be compensated for, or can be compensated for only slowly. In a situation such as this, the loss of dishwashing liquid in the cleaning zone must therefore be compensated for by supplying fresh water.

This solution has the disadvantage that, in the case of the alkaline cleaning zone, cleaner must be added to the fresh water that is supplied, in order to maintain the cleaning performance in this treatment zone. If the fresh water that is supplied is not at least at the same temperature, heating energy must additionally also be supplied to it. The two factors have a disadvantageous effect on the operating costs of the continuous-flow dishwashing machine.

The dishwashing liquid loss mentioned above occurs in the case of continuous-flow dishwashing machines in particular when the items to be cleaned are large or long, thus resulting in the dishwashing liquid being dragged along in the opposite direction to the transport direction of the feed means. This can result in a lack of dishwashing liquid in a subsequent cleaning zone in the transport direction. The flow of dishwashing liquid results from the dishwashing liquid which is sprayed onto the items to be cleaned running along them and also flowing to the previous treatment zone in the transport direction. If, for example, the dishwashing liquid level in the cleaning zone falls below a specific preset level, fresh water must be supplied via a separate filling line to the corresponding dishwashing liquid reservoir tank. A solution such as this is disclosed in EP 0 838 190 B1.

DE 10 2005 015 157 A1 discloses a method for operating a continuous-flow dishwashing machine in which the dishwashing liquid which leaves the initial cleaning zone in the direction of the waste water is stored in a further reservoir tank up to a predetermined level in order to allow it to be supplied to the cleaning zone via a further pump in the event of a lack of dishwashing liquid in the cleaning zone, in predetermined cleaning zone conditions. The lack of dishwashing liquid in the cleaning zone can therefore be compensated for without any further requirement for fresh water. This method has the disadvantage that the dishwashing liquid which is located in the further reservoir tank and is loaded with food residues can result in bacterial contamination, or may already be subject to bacterial contamination as a result of the food residues being rinsed away. This process is assisted because the temperature in the previous initial cleaning zones is normally about 40° C., therefore resulting in ideal preconditions for bacterial growth. This bacterial contamination can be cleared away only by greater cleaning effort in the reservoir tank after the end of operation, which in turn is associated with costs and is therefore undesirable.

A further disadvantage results from the relatively low temperature of this dishwashing liquid. If this dishwashing liquid is pumped back into the cleaning zone the temperature of the dishwashing liquid falls there. This is undesirable since this results in a decrease in the cleaning effect of the alkaline dishwashing liquid, necessitating reheating of the dishwashing liquid in the cleaning zone. Since the temperature cannot be increased suddenly, this treatment zone is therefore operated at an excessively low temperature at least at times, which is in turn noticeable in reduced cleaning performance.

A further disadvantage is that, in some circumstances, food residues and bacteria are pumped back into the cleaning zone, which can once again lead to reduced cleaner performance, particularly in terms of bacteria remaining on the items that have been cleaned.

DE 10 2005 030 720 A1 adopts a similar approach. In this method, in certain preconditions, the overflow from the initial cleaning zone can be switched over by a valve to the overflow to the waste water, in which case this valve can be moved by a control apparatus by at least one signal (which is dependent on the operating mode) from an open state to an at least partially closed state. Liquid for reuse in the continuous-flow dishwashing machine can therefore build up in the initial cleaning zone, which has the overflow. This solution has the advantage over the solution according to DE 10 2005 015 157 A1 that, in this case, no further reservoir container is used, with the disadvantages described above. However, the solution according to DE 10 2005 030 720 A1 has the disadvantage that the dishwashing liquid in the initial cleaning zone and that in the cleaning zone can be mixed with one another. This is particularly undesirable since, as already described above, food residues and bacteria may be located in the dishwashing liquid in the initial cleaning zone, necessarily passing in the case of this method into the cleaning zone, while they reduce the cleaning performance in that cleaning zone.

DE 10 2005 035 764 A1 discloses a further possible way to compensate for possible loss of dishwashing liquid in the cleaning zone or initial cleaning zone, without supplying fresh water. In this case, the fresh water, which has been sprayed into the fresh-water rinsing zone is trapped in a dishwashing liquid reservoir tank, and is once again sprayed over the items to be cleaned, by means of a circulation pump and associated nozzles. The dishwashing liquid reservoir tank has an overflow via which the fresh-water flow which is permanently supplied to the rinsing zone is carried away, beyond a specific level, in the direction of a separate reservoir container. The liquid that has been stored is supplied to the appropriate treatment zones from this reservoir container in accordance with the predetermined control parameter, specifically the requirement situation and in particular the filling state of the treatment zones, via appropriate apparatuses. This solution has the disadvantage of high costs resulting from the additional reservoir container and the risk of bacterial contamination of the container, and, associated with this, the cleaning effort required to keep this reservoir container free of bacteria.

DE 39 38 755 A1 describes a method in which dishwashing 15 liquid is supplied to the individual treatment zones from the rinsing zone via appropriate apparatuses. In this case, the major aim is to save cleaner in the main washing zone. The dishwashing liquid losses resulting from flow are not considered, or compensated for, in this embodiment.

### SUMMARY OF THE INVENTION

It is therefore an object of the present invention to provide a method for operating a continuous-flow dishwashing machine in a manner which saves fresh water, and which avoids the disadvantages described above.

According to an embodiment, a dishwashing liquid reservoir tank that is designed to be appropriately large in the rinsing zone can at the same time also be used as a dishwashing liquid buffer without any need for a specific reservoir container, which would result in additional costs. The invention proposes that any loss of dishwashing liquid in the cleaning zone be compensated for without using fresh water by storing an appropriately large volume of dishwashing liquid in the dishwashing liquid reservoir tank for the rinsing zone, and by passing dishwashing liquid in a controlled manner from the dishwashing liquid reservoir tank for the rinsing zone into at least one bypass line or to the cleaning zone.

However, this liquid is passed on in a controlled manner only governed by the controller for the continuous-flow dishwashing machine, for example in specific operating states of the continuous-flow dishwashing machine in which it is necessary and desirable to pass on this liquid.

The solution proposed according to the invention means that the dishwashing liquid reservoir tank for the at least one rinsing zone, which comprises a fresh-water rinsing zone and a pump rinsing zone, can be used as a dishwashing liquid buffer, and preferably heated fresh water can be supplied as required from this dishwashing liquid reservoir tank either to a treatment zone upstream of this dishwashing liquid reservoir tank, such as a further cleaning zone, or to an initial clearance or initial cleaner zone. The dishwashing liquid reservoir tank preferably has an associated level detection means, which is itself connected to the controller for the continuous-flow dishwashing machine. The cleaning zone preceding at least one rinsing zone likewise has an associated level detection means, which is likewise connected to the controller for the continuous-flow dishwashing machine. The two level detection devices signal to the controller the respective dishwashing liquid states in the treatment zones.

The controller for the continuous-flow dishwashing machine preferably controls the supply of dishwashing liquid from the dishwashing liquid reservoir tank for the at least one rinsing zone to the at least one cleaning zone and/or to the at least one initial cleaning zone as a function of the current operating state of the continuous-flow dishwashing machine. The controller is in this case at a higher level than the control for the level states in the cleaning zone and/or the initial cleaning zone, or in the reservoir tanks associated with these zones, so that it enables or inhibits the control process depending on the current operating state. The controller preferably controls the control process as a function of the current program point in the dishwashing program for the continuous-flow dishwashing machine. However, for example, the controller can also make use of parameters such as temperatures or degree of contamination (which may be determined by a cloudiness sensor) to allow or to inhibit the supply of dishwashing liquid from the dishwashing liquid reservoir tank for the at least one rinsing zone to the at least one cleaning zone and/or to the at least one initial cleaning zone.

Depending on the preset from this controller (in particular if the controller allows this as a function of the current operating state of the continuous-flow dishwashing machine), dishwashing liquid can now be supplied from the at least one rinsing zone either to the at least one cleaning zone upstream of it and/or to the at least one initial cleaning zone. In this case, the decision regarding which of the zones that have been mentioned the dishwashing liquid will be supplied to from the at least one rinsing zone is once again dependent on level states in the at least one cleaning zone and the at least one rinsing zone. These level states are once again known by virtue of the level detection means for machine control.

The amount of dishwashing liquid stored in the dishwashing liquid reservoir tank for the at least one rinsing zone can be controlled by the amount of dishwashing liquid introduced into these treatment zones by controlling the opening position of valves in bypass lines, which respectively open into the at least one initial cleaning zone or into the at least one cleaning zone. The machine control ensures that a minimum level which must be maintained is not undershot in the dishwashing liquid reservoir tank for the at least one rinsing zone. The level state within the dishwashing liquid reservoir tank oscillates between a maximum level and a normal level. If, for example, liquid is dragged along by long items to be washed which have been transported through the continuous-flow dishwashing machine, this can result in a drop in the level of the dishwashing liquid, for example in the dishwashing liquid reservoir tank for the cleaning zone, so that this can be supplemented again from the dishwashing liquid reservoir tank for the at least one rinsing zone by opening an electrically operable valve in a bypass line, or by switching on a pump, until the minimum predetermined level in this zone is reached.

If the liquid level of the dishwashing liquid in the dishwashing liquid reservoir tank falls below a minimum level as a result of a relatively large volume having been removed, a fresh-water supply line, through which preferably heated (60° C.) fresh water is passed into the dishwashing liquid reservoir tank, is opened and the liquid volume there is replenished to the minimum level again.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a first embodiment of a continuous-flow dishwashing machine as proposed according to the invention;

FIG. 2 shows an illustration of the tanks associated with the treatment zones; and

FIG. 3 shows a schematic illustration of a second embodiment of a continuous-flow dishwashing machine as proposed according to the invention.

### DETAILED DESCRIPTION

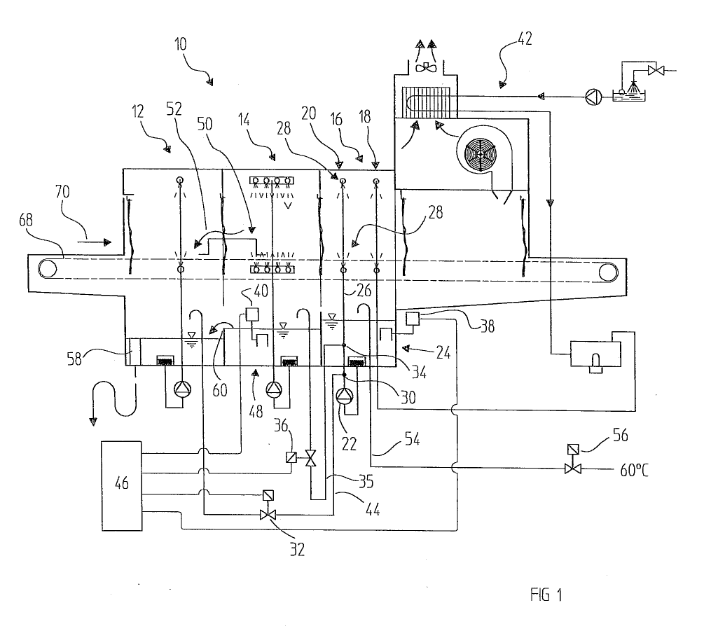

The illustration in FIG. 1 shows a continuous-flow dishwashing machine which is annotated with the reference symbol 10. The continuous-flow dishwashing machine 10 has an initial cleaning zone 12, at least one cleaning zone 14, a rinsing zone 16 and a drying zone 42. The rinsing zone 16 in the illustration shown in FIG. 1 is subdivided into a fresh-water rinsing zone 18 and a pump rinsing zone 20. Items to be cleaned 50 are fed by a feed means 68 in the transport direction 70 through the successive treatment zones of the continuous-flow dishwashing machine 10 as shown in the illustration in FIG. 1.

A circulation pump 22 in the rinsing zone 16 sucks dishwashing liquid up out of a dishwashing liquid reservoir tank 24 and the rinsing zone 16, and feeds this liquid via a line 26 to the spray nozzles 28 in the rinsing zone 16. A bypass 30 with an electrically operable valve 32, which is arranged in a bypass line 44 to the initial cleaning zone 12 or to the waste water, branches off from a line 26 and can be opened or closed on the basis of signals from a controller 46. This makes it possible to control the volume which flows away via the bypass line 44.

A further bypass, which is annotated with the reference symbol 34, likewise branches off from the line 26 into the bypass line 35, and likewise has an electrically operable valve 36 which can be opened or closed on the basis of signals from the controller 46. The line 34 opens into the at least one cleaning zone 14. The volume which flows via this line, the bypass 34, can be controlled by the electrically operable valve 36.

A dishwashing liquid reservoir tank 24 for the rinsing zone 16 and a dishwashing liquid reservoir tank 48 for the at least one cleaning zone 14 have respective level detection means 38 and 40, by means of which the tank levels of the at least one cleaning zone 14 and of the at least one rinsing zone 16 are transmitted to the controller 46. If a continuous-flow dishwashing machine 10 designed in this way is fed with long items to be cleaned 50 through the individual treatment zones, the surface area of the items to be cleaned 50 can result in a loss of dishwashing liquid in the dishwashing liquid reservoir tank 48, which is associated with the at least one cleaning zone 14, along the flow direction 52.

During normal operation of a continuous-flow dishwashing machine 10, a dishwashing liquid reservoir tank level is set on the basis of an overflow 58, in the initial cleaning zone 12. A dishwashing liquid reservoir tank level corresponding to the height of a cascade 60 between the cleaning zone 14 and the initial cleaning zone 12 is set in the cleaning zone 14.

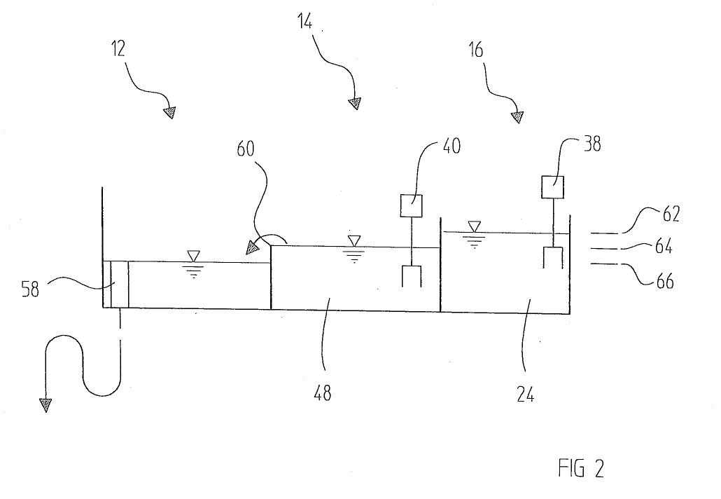

The dishwashing liquid level in the dishwashing liquid 5 reservoir tank which is associated with the rinsing zone 16 is controlled by means of the level detection means 38 and the controller 46. The fresh water which is supplied via the fresh-water rinsing 18 for the rinsing zone 16 is supplied either to the initial cleaning zone 12 or to the at least one cleaning zone, governed by the controller 46. For this purpose, from time to time, the controller 46 opens or closes either one or the other of the two electrically operable valves 32, 36, or opens or closes both of them at the same time, in the bypass 34 to the at least one cleaning zone 14 or in the bypass line 44 to the at least one initial cleaning zone 12. In consequence, the level in the dishwashing liquid tank 24 of the rinsing zone 16 oscillates between a maximum level 62 and a normal level 64, as is illustrated in FIG. 2.

If long items to be cleaned 50 result in a lack of dishwashing liquid in the dishwashing liquid reservoir tank 48 for the at least one cleaning zone 14, as a result of dishwashing liquid being dragged along, or if the level falls below a predetermined level, dishwashing liquid is passed via the first bypass 34 and the valve 36 from the rinsing liquid reservoir tank 24 into the at least one cleaning zone 14 until the minimum predetermined level is set again in the at least one cleaning zone 14.

In this case, a minimum level 66 to be maintained in the dishwashing liquid reservoir tank 24 of the rinsing zone 16 must not be undershot. Fresh water, which is preferably heated (for example at 60° C.) fresh water, can be supplied to the rinsing zone 16 via a separate filling line 54 and an electrically operable valve 56 only when the stored volume of liquid which is buffered in the at. least one cleaning zone 14 in the dishwashing liquid reservoir tank 24 for the at least one rinsing zone 16 is no longer adequate to compensate for the dishwashing liquid losses. From there, it is passed on the route described above into the at least one cleaning zone 14.

If the dishwashing liquid level in the dishwashing liquid reservoir tank 24 for the rinsing zone 16 falls below the normal level 64 or the minimum level 66, dishwashing liquid from the rinsing zone is not passed out either via the bypass 30 with the valve 32 or the further bypass 34 with the further valve 36. This ensures that an adequate amount of dishwashing liquid from the rinsing zone 16 is always available to compensate for dishwashing liquid losses in the at least one cleaning zone 14.

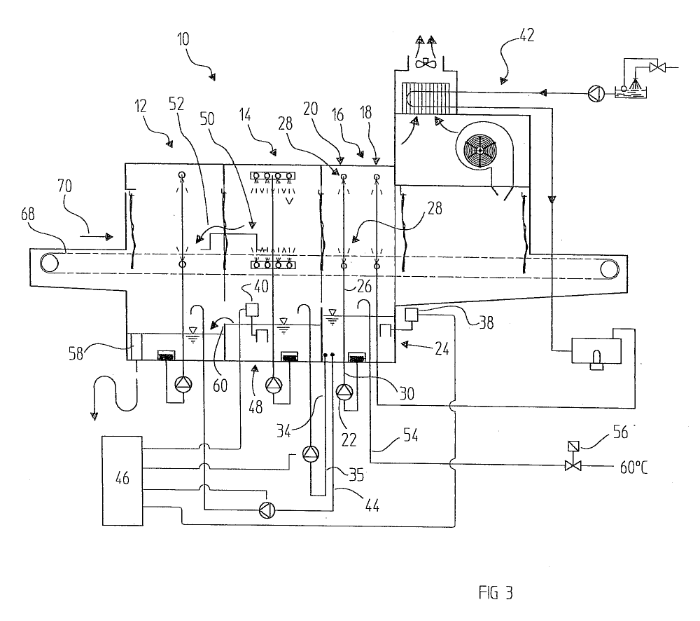

Alternatively, instead of the bypass 34 and the bypass line 44, and the electrically operable valves 32, 36 arranged in them, separate pumps with appropriate lines into the respective treatment zones can also be used and can then be switched on and off again analogously to the electrically operable valves 32, 36, governed by the controller 46. This embodiment variant, as shown in FIG. 3, has the advantage that, because of the large cross sections, pumps are less susceptible to dirt.

The system described above results in a continuous-flow dishwashing machine 10 which allows water-saving and energy-saving operation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a continuous-flow dishwashing machine for cleaning items to be cleaned, the method comprising:
transporting, via a feed device, the items to be cleaned through successive treatment zones in the continuous-flow dishwashing machine, which has at least one cleaning zone and at least one rinsing zone; and
supplying dishwashing liquid, which is governed by a controller, from a dishwashing liquid reservoir tank for the at least one rinsing zone to the at least one cleaning zone and/or at least one initial cleaning zone as a function of at least one level state in the at least one cleaning zone and the at least one rinsing zone.

2. The method as claimed in claim 1, wherein any dishwashing liquid loss in at least one initial cleaning zone or at least one cleaning zone is compensated for by supplying dishwashing water from the at least one rinsing zone.

3. The method as claimed in claim 1, wherein the level state of the dishwashing liquid in the at least one rinsing zone is detected by a level detection device, and is transmitted to the controller.

4. The method as claimed in claim 1, wherein the controller controls the supply of dishwashing liquid from the dishwashing liquid reservoir tank for the at least one rinsing zone to the at least one cleaning zone and/or to the at least one initial cleaning zone as a function of a current operating state of the continuous-flow dishwashing machine.

5. The method as claimed in claim 1, wherein the level state of the dishwashing liquid in the at least one cleaning zone is detected by a level detection device and is transmitted to the controller.

6. The method as claimed in claim 3, wherein, governed by the controller at least one valve, which is operated electrically and is located in at least one line to at least one initial cleaning zone or to at least one cleaning zone, is opened or closed.

7. The method as claimed in claim 3, wherein, governed by the controller, a pump which is arranged in the at least one rinsing zone is switched on or off in order to feed dishwashing liquid from the dishwashing liquid reservoir tank into the at least one cleaning zone or the at least one initial cleaning zone.

8. The method as claimed in claim 1, wherein the level state in the dishwashing liquid tank for the at least one rinsing zone fluctuates between a maximum level state and a normal level.

9. The method as claimed in claim 1, wherein, if the level in the dishwashing liquid reservoir tank for the at least one rinsing zone falls below a minimum level, the reservoir tank is filled with fresh water, preferably with heated fresh water.

10. A continuous-flow dishwashing machine comprising:
at least one cleaning zone;
at least one rinsing zone;
a bypass that runs from a dishwashing liquid reservoir tank for the at least one rinsing zone to at least one cleaning zone; and
a bypass line that runs to at least one initial cleaning zone.

11. The continuous-flow dishwashing machine as claimed in claim 10, wherein an electrically operable valve is provided in the bypass and a further electrically operable valve is provided in the bypass line.

12. The continuous-flow dishwashing machine as claimed in claim 10, wherein the dishwashing liquid reservoir tank for the at least one rinsing zone has an associated level detection device.

13. The continuous-flow dishwashing machine as claimed in claim 10, wherein the at least one cleaning zone has a further associated level detection device.

14. The continuous-flow dishwashing machine as claimed in claim 12, wherein the level detection device is connected to the controller for the continuous-flow dishwashing machine.

15. The continuous-flow dishwashing machine as claimed in claim 10, wherein the bypass and/or the bypass line branch/branches off behind a pressure side of a circulation pump which is associated with the dishwashing liquid reservoir tank for the at least one rinsing zone.

16. The continuous-flow dishwashing machine as claimed in claim 10, wherein a pump which is switched on and off via a controller, is installed in the bypass and/or in the bypass line.
